(19) United States
(12) Patent Application Publication
(10) Pub. No.: US 2026/0170019 A1
(43) Pub. Date: Jun. 18, 2026

(54) SYSTEM AND METHOD FOR SEMANTIC MACHINE LEARNING FEATURE SEARCH AND REUSABILITY IN FEATURE STORES USING ARTIFICIAL INTELLIGENCE EMBEDDING MODELS

(71) Applicant: Wix.com Ltd., Tel Aviv (IL)

(72) Inventor: Ziv LEVY, Givatayim (IL)

(21) Appl. No.: 19/419,180

(22) Filed: Dec. 15, 2025

Related U.S. Application Data
(60) Provisional application No. 63/734,786, filed on Dec. 17, 2024.

(51) Int. Cl. G06F 16/28; G06F 16/21

(52) U.S. Cl. CPC G06F 16/289; G06F 16/211

(57) ABSTRACT

A system for automatic generation of machine learning feature definitions includes a feature schema, a user interface, a large language model (LLM), and a feature database. The feature schema defines a structured representation of a machine learning feature, including event fields, filter fields, and aggregation or categorical calculation fields. The user interface receives a natural language description of a desired feature from a user. The large language model generates, based on the natural language description and the feature schema, a candidate feature definition that conforms to the structured representation. The feature database then stores the candidate feature definition as a feature object for subsequent use in training or serving a machine learning model.

### CROSS REFERENCE TO RELATED APPLICATIONS

This application claims priority from U.S. provisional patent application 63/734,786, filed Dec. 17, 2024, which is incorporated herein by reference.

### FIELD OF THE INVENTION

The present invention relates generally to machine learning systems and to semantic feature search and reusability in feature stores in particular.

### BACKGROUND OF THE INVENTION

In the field of machine learning and artificial intelligence, data scientists rely on feature stores to manage and organize the input data used to train models and define features. These feature stores serve as centralized repositories for storing, managing, and accessing features, which are individual measurable properties or characteristics of observed phenomena. As the complexity and scale of machine learning projects grow, the management and utilization of features have become increasingly important.

Feature stores are used in streamlining the machine learning workflow by allowing data scientists to reuse features across different projects and teams. Traditional database systems used for feature stores typically rely on search functionalities, such as keyword matching or metadata filtering, which allow users to query for features.

The nature of feature definitions can be complex, and may include various calculations, transformations, and business logic. These feature definitions may be stored (for example) in complex data structures or binary large objects (BLOBs) within databases.

### SUMMARY OF THE PRESENT INVENTION

There is therefore provided, in accordance with a preferred embodiment of the present invention, a system for automatic generation of machine learning feature definitions. The system includes a feature schema, a user interface, a large language model (LLM), and a feature database. The feature schema defines a structured representation of a machine learning feature, including event fields, filter fields and aggregation or categorical calculation fields. The user interface is configured to receive a natural language description of a desired feature from a user. The large language model (LLM) is configured to generate, based on the natural language description and the feature schema, a candidate feature definition that conforms to the structured representation. The feature database is configured to store the candidate feature definition as a feature object for subsequent use in training or serving a machine learning model.

Still further, in accordance with a preferred embodiment of the present invention, the natural language description includes at least one of a business goal, event filters, aggregation logic, or time windows.

Additionally, in accordance with a preferred embodiment of the present invention, the system further includes a template repository configured to store one or more feature definition templates, and where the LLM is further configured to generate the candidate feature definition based on the natural language description, the feature schema, and at least one of the one or more feature definition templates.

Moreover, in accordance with a preferred embodiment of the present invention, the candidate feature definition generated by the LLM is a JSON or a Protobuf object.

Further, in accordance with a preferred embodiment of the present invention, the JSON or the Protobuf object encodes events, filters, aggregation or categorical rules, and associated metadata matching the natural language description.

Still further, in accordance with a preferred embodiment of the present invention, the user interface is further configured to present the candidate feature definition to the user for review and optional modification, and where the feature database is configured to store the candidate feature definition upon receiving an approval from the user.

Additionally, in accordance with a preferred embodiment of the present invention, the system further includes a feature serializer, a vector embedder, and a vector database, where upon the user approval, the feature serializer and the vector embedder are configured to generate and store a corresponding semantic embedding of the candidate feature definition in the vector database.

Moreover, in accordance with a preferred embodiment of the present invention, the user interface includes at least one of a web service, an application programming interface (API), a command-line-based interface, or a graphical user interface.

Further, in accordance with a preferred embodiment of the present invention, the feature schema defines the structured representation to include fields for a feature identifier, one or more data sources, filter conditions, and aggregation functions.

Still further, in accordance with a preferred embodiment of the present invention, the user interface is further configured to receive the natural language description in response to a creation request from the user, the creation request being initiated following a semantic search that did not identify a feature satisfying a user-specified criterion.

There is therefore provided, in accordance with a preferred embodiment of the present invention, a method for automatic generation of machine learning feature definitions. The method includes receiving a natural language description of a desired feature from a user, generating, utilizing a large language model (LLM) and based on the natural language description and a feature schema, a candidate feature definition that conforms to a structured representation defined by the feature schema, where the structured representation includes event fields, filter fields and aggregation or categorical calculation fields, and storing the candidate feature definition as a feature object for subsequent use in training or serving a machine learning model.

Additionally, in accordance with a preferred embodiment of the present invention, the natural language description includes at least one of a business goal, event filters, aggregation logic, or time windows.

Moreover, in accordance with a preferred embodiment of the present invention, the generating the candidate feature definition is further based on at least one of one or more stored feature definition templates.

Further, in accordance with a preferred embodiment of the present invention, the generated candidate feature definition is a JSON or a Protobuf object.

Still further, in accordance with a preferred embodiment of the present invention, the JSON or the Protobuf object encodes events, filters, aggregation or categorical rules, and associated metadata matching the natural language description.

Additionally, in accordance with a preferred embodiment of the present invention, the method further includes presenting the candidate feature definition to the user for review and optional modification, and receiving an approval from the user prior to the storing of the candidate feature definition.

Moreover, in accordance with a preferred embodiment of the present invention, the method further includes, upon receiving the approval from the user, generating a corresponding semantic embedding of the candidate feature definition, and storing the semantic embedding.

Further, in accordance with a preferred embodiment of the present invention, the receiving the natural language description is performed via at least one of a web service, an application programming interface (API), a command-line-based interface, or a graphical user interface.

Still further, in accordance with a preferred embodiment of the present invention, the structured representation defined by the feature schema further includes fields for a feature identifier, one or more data sources, filter conditions, and aggregation functions.

Additionally, in accordance with a preferred embodiment of the present invention, the receiving the natural language description is performed in response to a creation request from the user, the creation request being initiated following a semantic search that did not identify a feature satisfying a user-specified criterion.

There is therefore provided, in accordance with a preferred embodiment of the present invention, a system for semantic machine learning feature search. The system includes a feature database, a feature serializer, a vector embedder, a vector database, and a feature retrieval module. The feature database is to store structured feature definitions. The feature serializer is configured to process a structured feature definition from the feature database to extract key information including calculations and filter conditions and generate a natural-language description of the feature definition by utilizing a large language model (LLM) based on the extracted key information. The vector embedder is configured to convert the natural-language description into a high-dimensional numerical vector representation of the semantic meaning of the feature definition. The vector database is configured to store the high-dimensional numerical vector representation. The feature retrieval module is configured to receive a natural language query, generate a query vector from the natural language query using the vector embedder, perform a similarity search for a feature within the vector database using the query vector, and provide a ranked list of features based on semantic similarity.

Moreover, in accordance with a preferred embodiment of the present invention, the feature serializer further includes a deconstructor and interpreter, a prompt creator, an LLM enricher, and an output generator. The deconstructor and interpreter is configured to parse the structured feature definition to extract a plurality of logical facts therefrom. The prompt creator is configured to assemble the plurality of logical facts into a structured prompt. The LLM enricher is configured to manage interaction with the LLM utilizing the structured prompt to generate the natural-language description. The output generator is configured to receive the natural-language description from the LLM enricher and provide the natural-language description to the vector embedder.

Further, in accordance with a preferred embodiment of the present invention, the feature retrieval module further includes a query input handler, a query embedder, a vector searcher, and a result processor. The query input handler is configured to parse the natural language query. The query embedder is configured to utilize the vector embedder to generate the query vector from the natural language query. The vector searcher is configured to perform the similarity search for a feature within the vector database using the query vector. The result processor is configured to compile the ranked list of features based on results from the vector searcher.

Still further, in accordance with a preferred embodiment of the present invention, the system is further configured to automatically generate a new structured feature definition when the similarity search does not identify a feature that satisfies a user specified criterion. The feature retrieval module is further configured to receive a natural language request describing a desired feature. The feature serializer is further configured to provide the natural language request to the LLM together with one or more feature definition templates. The LLM is configured to generate, based on the natural language request and the templates, a candidate structured feature definition that conforms to a schema of the feature database. The feature database is configured to store the candidate structured feature definition as a new feature upon user approval.

Additionally, in accordance with a preferred embodiment of the present invention, the schema defines a feature object including fields for at least one event source identifier, a plurality of event items each having a set of event filters, and at least one aggregation or categorical calculation rule, as represented in a JSON or Protobuf structure.

Moreover, in accordance with a preferred embodiment of the present invention, the LLM is further configured to generate the candidate structured feature definition by outputting a JSON or Protobuf object whose fields encode event filters, base events, time periods and aggregation functions derived from the natural language request.

Further, in accordance with a preferred embodiment of the present invention, the system further includes a database synchronizer configured to perform a bulk synchronization process that iterates over feature definitions stored in the feature database or in an external feature store, for each feature definition, invokes the feature serializer and the vector embedder to generate a corresponding embedding vector, and stores the embedding vector in the vector database such that each feature definition in the feature database has a corresponding embedding vector.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of duplication that may occur in a conventional feature store

FIG. 2 is a schematic block diagram illustration of a semantic feature search and management system, constructed and operative in accordance with an embodiment of the present invention;

FIGS. 3A-3D together are a schematic illustration of an example feature object definition, in accordance with an embodiment of the present invention;

FIG. 4 is a schematic block diagram illustration of a feature receiver and cataloger of the system of FIG. 2, constructed and operative in accordance with an embodiment of the present invention;

FIG. 5 is a schematic block diagram illustration of a feature serializer of the system of FIG. 2, constructed and operative in accordance with an embodiment of the present invention;

FIG. 6 is an illustration of an example prompt for an LLM based on the output of the feature serializer of FIG. 5;

FIG. 7 is an illustration of an example LLM training methodology, in accordance with an embodiment of the present invention;

FIG. 8 is a screenshot illustration of an example user interface for semantic feature search, constructed and operative in accordance with an embodiment of the present invention; and

FIG. 9 is a schematic block diagram illustration of a feature retrieval module of the system of FIG. 2, constructed and operative in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that as the scale and complexity of machine learning projects grow, the discoverability and reusability of features within existing feature stores is important as organizations seek to manage their data and the development of machine learning models and can be challenging.

Traditional database systems and search functionalities, which rely on keyword matching or metadata filtering, often fall short in understanding the semantic meaning and context of features. This limitation makes it difficult for data scientists to effectively search for and discover features that may be conceptually similar but are described using different terminology. The ability to efficiently search, discover, and reuse existing features is becoming increasingly important as organizations seek to maximize the value of their data and accelerate the development of machine learning models. Improved feature discoverability and reusability can lead to faster model development cycles, more consistent feature definitions across an organization, and better-performing machine learning models.

Applicant has further realized that the complex nature of feature definitions, which can include intricate calculations, transformations, and business logic often stored in complex data structures or binary large objects (BLOBs), adds another layer of complexity that standard search mechanisms are inadequate to query. As a result, data scientists frequently resort to creating new features from scratch, even when similar or identical features may already exist. This leads to inefficient use of resources, unnecessary duplication of effort, increased maintenance overhead, and potential inconsistencies in how features are defined and calculated across different projects.

As the field of machine learning continues to evolve, there is a growing need for improved feature discoverability and reusability within feature stores. Such solutions can significantly enhance the productivity of data scientists and the efficiency of machine learning workflows. Conventional database systems, such as Structured Query Language (SQL) databases, often struggle to efficiently search within complex BLOB columns that store intricate feature definitions. Commercial machine learning platforms that provide feature stores typically rely on keyword based or metadata based search rather than semantic search over feature definitions using AI based embedding models as described herein.

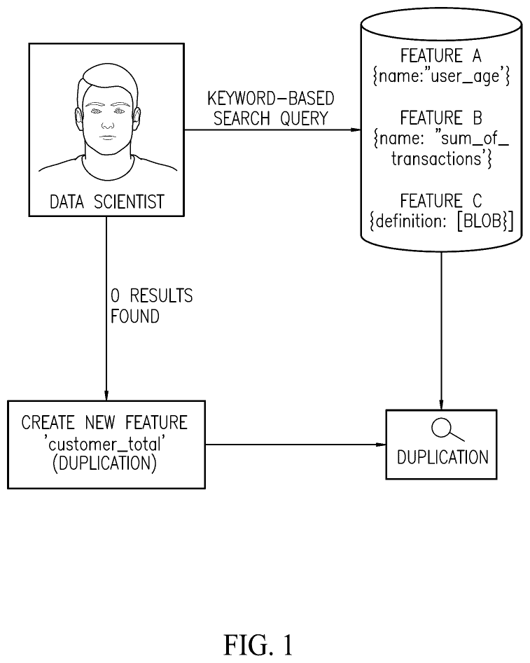

Reference is now made to FIG. 1, which illustrates duplication that may occur in conventional feature stores. It depicts a data scientist performing a keyword-based search that fails to identify a conceptually similar but differently named existing feature. This search failure consequently leads the data scientist to create a new, redundant feature, resulting in duplication within the feature store.

Applicant has realized that the above mentioned challenges may be addressed by providing an innovative system and method for improving the discoverability and reusability of features within a feature store. The system departs from conventional keyword-based search mechanisms by leveraging AI embedding models and semantic search technology. This transforms the search process into a “deep search” experience, akin to modern textual search, which is intuitive and user-friendly, thereby empowering data scientists to identify and reuse existing features with minimal effort.

Applicant has further realized that by mapping each feature's definition, including its name, description, underlying calculations, and filters, to a high-dimensional numerical vector using AI embedding models, it is possible to create a semantic representation of the feature's essential characteristics. These embedded vectors are persisted in a specialized vector database, creating a new, technically improved data structure that serves as a searchable index of the feature store's contents.

The system primarily involves several key components such as AI embedding models configured to generate embedded vectors that encapsulate a feature's essential characteristics, filters, and calculations; a semantic search engine that utilizes these embedded vectors to perform deep searches within the feature store; and feature store integration, which seamlessly integrates with existing feature stores to enhance functionality without significant modifications.

Throughout the application, the language of “embeddings” refers to a numerical representation of text that can be used to measure the relatedness between two pieces of text. Embeddings are particularly useful for tasks such as search, clustering, recommendations, anomaly detection, and classification.

Thus, when a data scientist (or other types of user such as a data engineer, analytics engineer or business intelligence (BI) engineer) requires a feature, they can formulate a query in natural language describing the feature's conceptual purpose. This query is itself converted into an embedded vector using the same AI model. The system then performs a similarity search within the vector database to find feature vectors that are semantically closest to the query vector. This process constitutes a concrete technological improvement that enhances the functionality of the feature store by enabling it to return a ranked list of relevant features based on meaning rather than syntax. This process constitutes a concrete technological improvement over conventional keyword-based feature search approaches, reduces resource wastage, minimizes feature duplication, and enhances overall productivity and consistency in the machine learning development workflow.

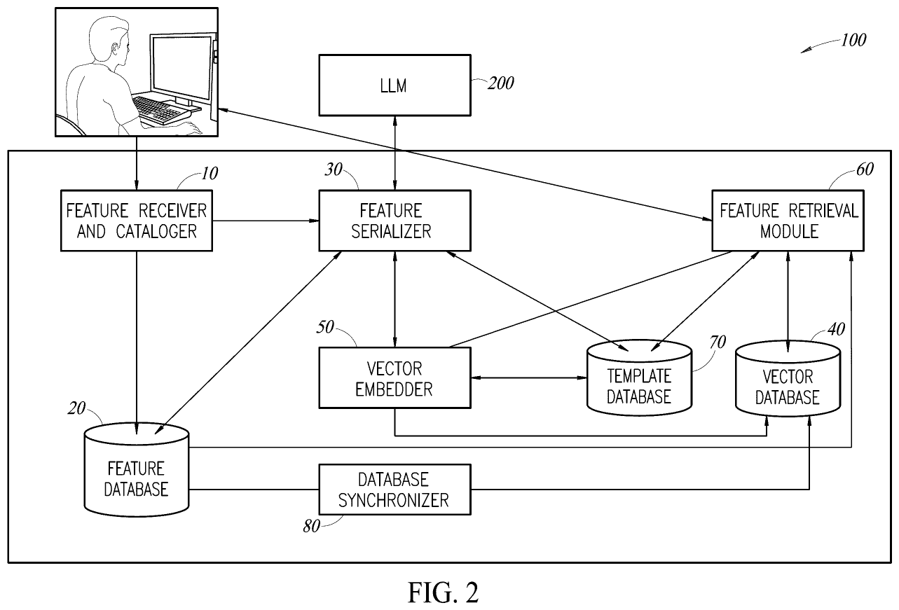

Reference is now made to FIG. 2 which illustrates a semantic feature search and management system 100, in accordance with an embodiment of the current invention. System 100 may be in direct communication with a Large Language Model (LLM) 200. In an alternative embodiment, LLM 200 may be integrated with system 100 as part of the inventive system.

It will be appreciated that system 100 may typically be implemented when developing large scale models for use in systems such as, but not limited to, website building systems and visual editing systems.

System 100 may comprise a feature receiver and cataloger 10, a feature database 20, a feature serializer 30, a vector database 40, a vector embedder 50, a feature retrieval module 60. a template repository 70 and a database synchronizer 80. The functionality of these elements is discussed in more detail herein below.

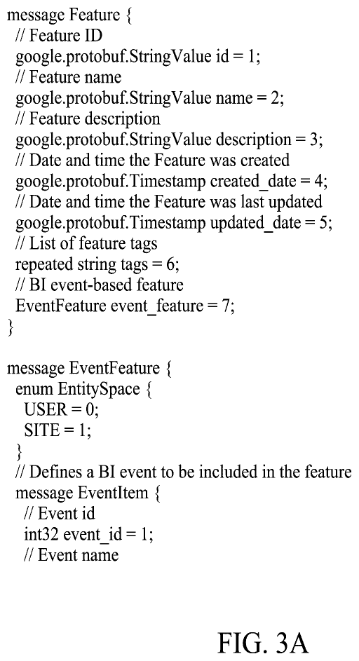

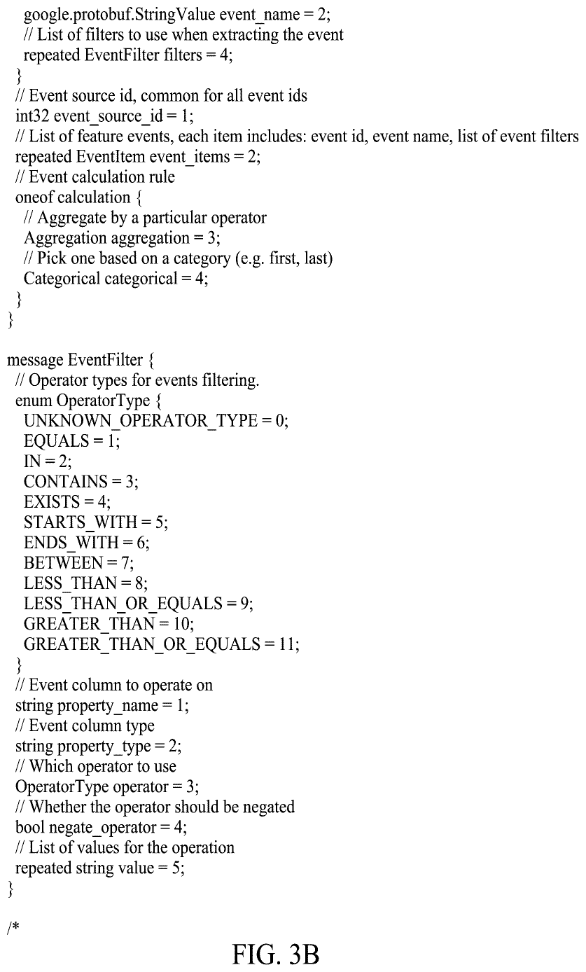

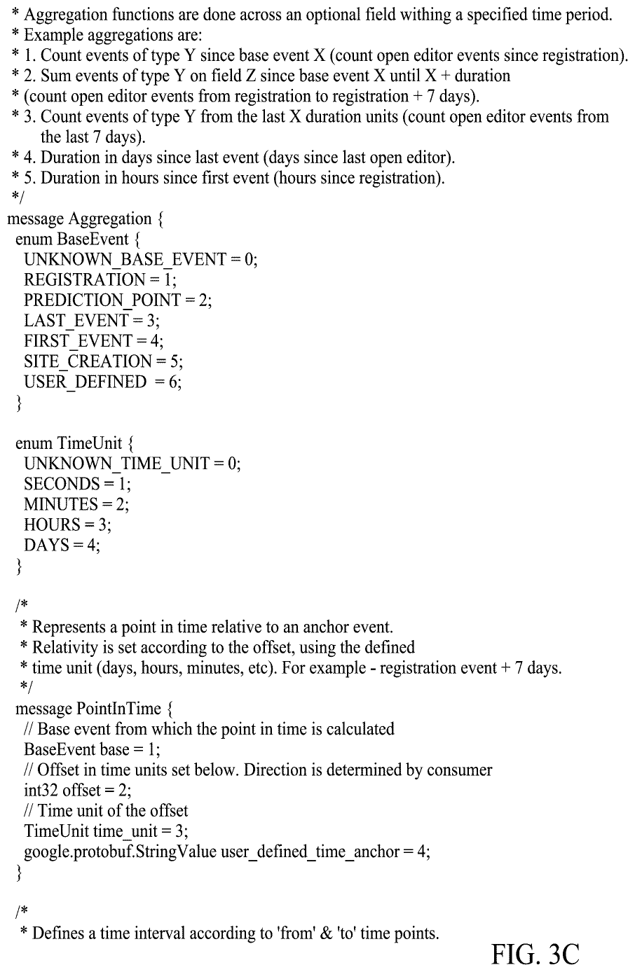

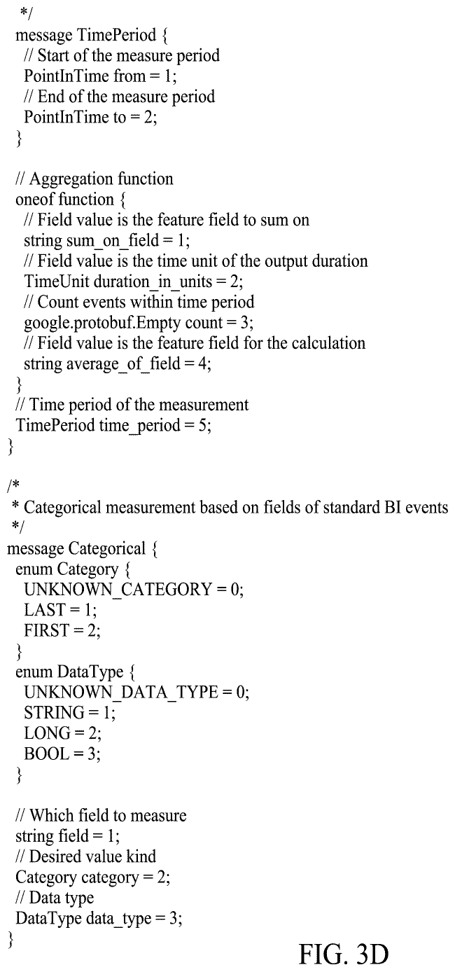

For the description herein, a ‘structured feature definition’ refers to a machine-readable object that specifies how a feature is computed. The structured feature definition may comprise a feature object that includes: (i) a feature identifier; (ii) an event source identifier (or other data-source identifier) identifying an event stream, table, or log source from which events are obtained; (iii) a plurality of event items, wherein each event item specifies at least an event type or event name and a corresponding set of event filters (e.g., field/operator/value expressions) that select a subset of events from the event source; (iv) one or more aggregation rules and/or categorical calculation rules defining how a feature value is computed from events matching the event filters (e.g., COUNT, SUM, AVERAGE, MAX, MIN, or categorical parameters); and (v) optional time window definitions defining a time span over which events are considered. FIGS. 3A-3D illustrate an example feature object encoded in a structured format such as JSON or Protobuf.

In an alternative embodiment, system 100 may be used with an existing feature store as described in more detail herein below.

Feature receiver and cataloger 10 may receive new feature definitions and organize and manage them within feature database 20. To enable semantic search, feature serializer 30 may extract key information from the feature definitions, leveraging LLM 200 to enrich the feature descriptions. These enriched descriptions are then converted into numerical vector representations by vector embedder 50 and stored in vector database 40. For feature discovery, a feature retrieval module 60 may process search queries and vectorize them using vector embedder 50 to enable a similarity search against vector database 40, and to retrieve corresponding feature definitions from feature database 20 for use.

As discussed herein above, system 100 may be used by users such as data scientists who build datasets to train their models. For example, a user A may create multiple features based on some business characteristics and attributes. For these features, they may set a name and description and add their calculation to be computed further in the process. User A then saves their work, which is stored in features database 20. Feature serializer 30 may extract key factors of the feature's definition and prompt LLM 200 for an enhanced description of the feature given the feature's properties, including User A's input for name and description. The overall object and enhanced description of the feature are then embedded by vector embedder 50 and saved in vector database 40.

In a later phase, another data scientist using system 100, user B, deals with another business case in the same domain as the previous data scientist, user A. User B is trying to look for an existing feature to get inspired or reuse. User B types a search phrase in natural language that describes the feature, such as “page load event in payments flow, filter for mobile devices and aggregation is the sum of all events from user registration to prediction point.”

Feature retrieval module 60 may process user B's request and search against the vector database 40 and return a suggested list of features that match the search. User B is also made aware of the similarity score the items in the list results got, so he may start pick the one with the highest score and see if it is relevant etc.

It will be appreciated that the data scientist may perform read/write operations for features to be processed by feature receiver and cataloger 10 using any suitable user interface. The same interface may also be used to access feature retrieval module 60 in order to search for existing features. In an alternative embodiment, two separate user interfaces may be used. It will also be appreciated that the user interface may be a service (including a web service, an application programming interface (API), or a serial peripheral interface (SPI)), a process, a command-line-based interface, a graphical user interface or any other technology.

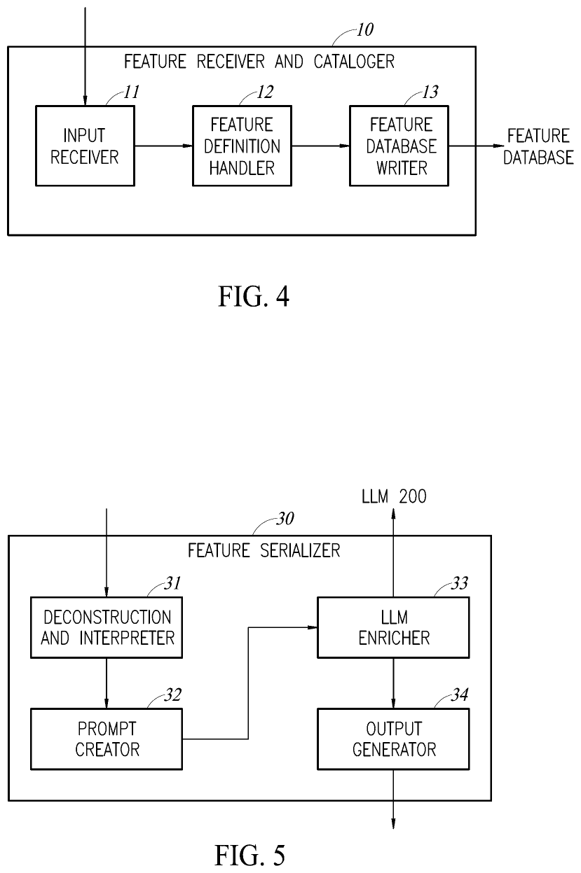

Feature receiver and cataloger 10 may enable fetching, creating, and modifying features in feature database 20. Reference is now made to FIG. 4 which illustrates the sub elements of feature receiver and cataloger 10. Feature receiver and cataloger 10 may comprise an input receiver 11, a feature definition handler 12 and a feature database writer 13.

Input receiver 11 may (via a suitable UI as discussed herein above) receive raw feature definitions. It may capture all user-provided information, such as the feature's name, descriptive text, filter definitions, category, aggregation calculations, and any other initial metadata.

Feature definition handler 12 may validate incoming feature definitions to ensure they adhere to predefined structures and data types. This may involve checking for completeness of required fields and correctness of data formats. It will be appreciated that there may be a minimal set of determined mandatory properties. Feature definition handler 12 may further handle feature metadata generation and management, automatically assigning and maintaining essential system-level information for each feature, including unique identifiers and lifecycle timestamps such as creation and last update dates. Finally, feature definition handler 12 may perform feature data normalization and structuring, transforming validated inputs into a consistent, standardized internal representation to ensure uniformity for storage in feature database 20. It will be appreciated that definition handler 12 may utilize data normalization and structuring via a variety of algorithms and techniques. For example:
If features are on very different scales, feature definition handler 12 may use scaling so that one feature does not dominate the other. For example, if a feature represents “user age” with values typically ranging from 18 to 65, while another feature represents “annual income” with values ranging from $20,000 to $500,000, these features are on very different scales. Without scaling, the income feature with its much larger numerical values would dominate machine learning algorithms compared to the age feature. Feature definition handler 12 may apply min-max scaling to normalize both features to a range of 0 to 1, or standardization to transform both features to have a mean of 0 and standard deviation of 1, ensuring that neither feature inappropriately influences the model due to its scale alone.
If features are skewed or have outliers, feature definition handler 12 may employ robust scaling or log/power transforms.
If data is categorical or mixed types, feature definition handler 12 may encode categories appropriately.
If many features exist and redundancy is suspected, feature definition handler 12 may use dimensionality reduction or feature selection.
If there is temporal or sequential data, feature definition handler 12 may derive lag/aggregate features to structure time-based patterns.
If there is online/in-production inference with real-time data, feature definition handler 12 may ensure that the same transformations (scaling, encoding) used at training are applied at inference (the feature store often helps ensure this consistency).

Feature database writer 13 may take the normalized and validated feature data and persist it reliably into feature database 20, ensuring data integrity and proper indexing for subsequent operations by feature serializer 30 and feature retrieval module 60.

Feature serializer 30 may extract the key factors of the feature definition, including filters and calculations. It may also use LLM 200 to re-describe the feature itself. The resulting information may be embedded and saved in vector database 40 using the exact same feature identifier used by feature database 20 for the pertinent feature. In particular, each embedded vector that is stored in vector database 40 may be associated with or indexed by, the same unique feature identifier used for the corresponding structured feature definition in feature database 20, thereby enabling efficient lookup of the underlying feature once a nearest neighboring vector is identified.

Reference is now made to FIG. 5 which illustrates sub elements of feature serializer 30. Feature serializer 30 may comprise a deconstructor and interpreter 31, a prompt creator 32, an LLM enricher 33 and an output generator 34.

Deconstructor and interpreter 31 may parse a structured feature definition object, such as one in JSON or Protobuf format (as is illustrated in FIGS. 3A-3D, received from feature receiver and cataloger 10 by navigating through the object's various fields, extracting, and interpreting each piece of logic to understand its role in the overall feature calculation. This may involve identifying a specific action (e.g., COUNT, SUM, AVERAGE), the target data, any filtering conditions, and the defined timeframe for the calculation.

Furthermore, deconstructor and interpreter 31 may perform beyond a simple data extraction, actively interpreting the meaning of operators (e.g., understanding that “IN” means checking against a list of values, and “BETWEEN” implies two values) and identifying the calculation type. At the culmination of this phase, deconstructor and interpreter 31 may produce a comprehensive collection of discrete, structured logical facts about the feature, which may serve as the foundation for the subsequent steps in generating a natural-language description.

Prompt creator 32 is responsible for assembling the discrete logical facts gathered by deconstructor and interpreter 31 into a high-quality, structured prompt. This prompt is specifically engineered to elicit an optimal response from LLM 200.

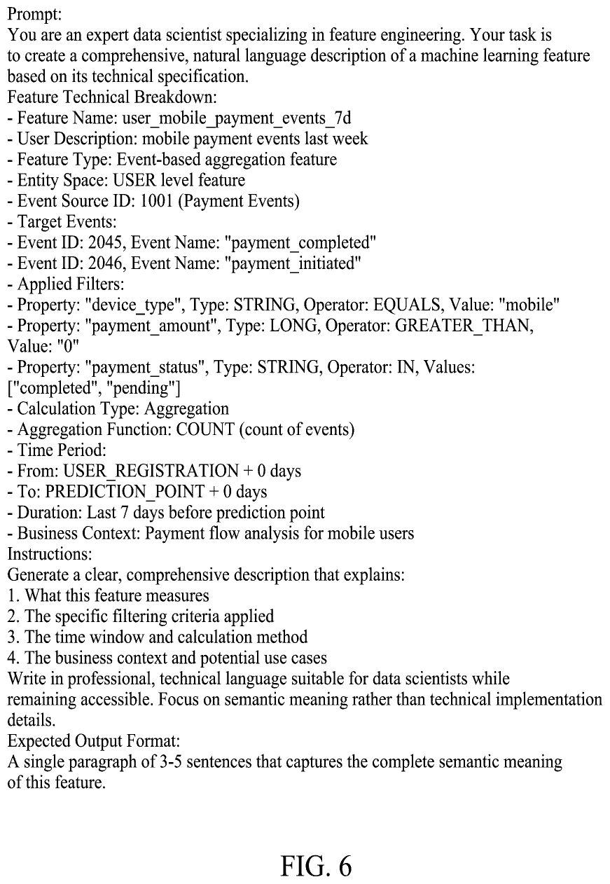

Prompt creator 32 may extract a suitable template from template repository 70 and populate the template according to the extracted features received from deconstructor and interpreter 31. Reference is now made to FIG. 6 which illustrates an example prompt used for LLM 200.

LLM enricher 33 may manage the interaction with LLM 200. Upon receiving the structured prompt from prompt creator 32, it may make an API call to LLM 200 (such as OpenAI's API or Google's Gemini API), sending the engineered prompt as the payload.

LLM 200 may then synthesize the discrete logical points of the feature breakdown into a fluent, cohesive, and technically accurate natural-language paragraph. This process represents the “enrichment” aspect, where the raw machine logic is translated into human-readable semantics, thus creating a high-quality text “surrogate” of the feature. The output from LLM 200 is a comprehensive and descriptive paragraph that accurately captures the essence of the feature's definition and functionality.

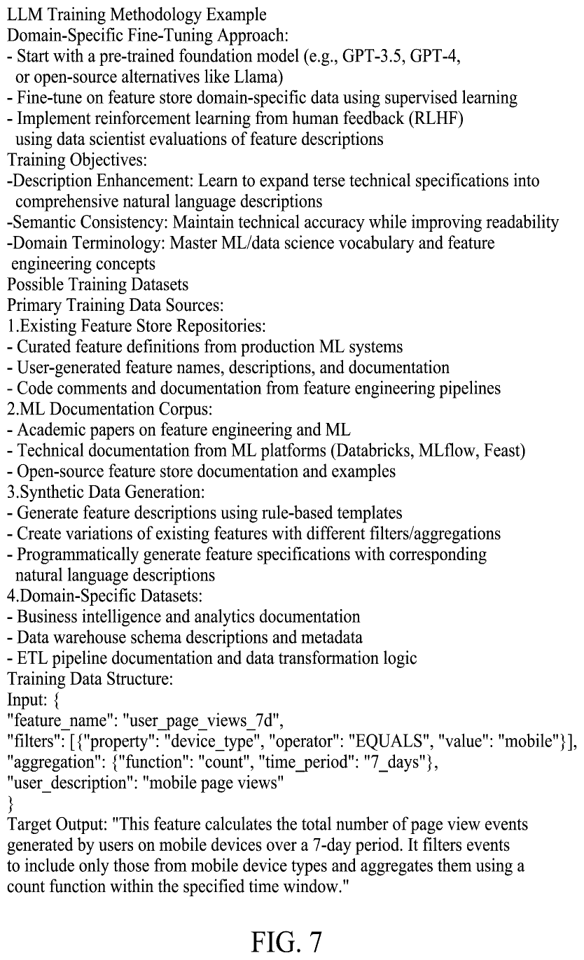

It will be appreciated that from the prompt of FIG. 6, LLM 200 may return the response of:
“This feature quantifies user engagement with payment functionality on mobile devices by counting payment-related events (both initiated and completed payments) within a 7-day window preceding the prediction point. The calculation specifically filters for mobile device interactions where payment amounts are greater than zero and payment status is either completed or pending, providing insights into mobile payment behavior patterns. The feature aggregates events from the user's registration date up to the prediction point, making it valuable for analyzing mobile payment adoption, transaction frequency, and user engagement in mobile commerce scenarios. This metric is particularly useful for predicting user lifetime value, payment conversion rates, and mobile-specific user behavior in e-commerce or fintech applications.”
It will also be appreciated that in an alternative embodiment, LLM 200 may be trained to generate the enriched description. Reference is now made to FIG. 7 which illustrates an example LLM training methodology example. As is illustrated, a main-specific fine-tuning methodology for LLMs is provided leveraging pre-trained models and fine-tuning them with feature store data and human feedback to improve description enhancement, semantic consistency, and mastery of domain-specific terminology.

Output generator 34 may receive the natural-language text paragraph directly from LLM enricher 33. This output may be a single, high-fidelity string of text that semantically represents the original, complex feature object in a human-understandable format.

Once this enriched text is generated, output generator 34 may pass the text to vector embedder 50 which may convert the clear, descriptive text received from LLM 200 into a powerful and accurate vector embedding. Output generator 34 may save the vector embedding vector database 40 using the exact same feature identifier as the original feature, facilitating semantic search and reusability.

It will be appreciated that embeddings are fundamentally numerical representations of text that allow for measuring the relatedness between different pieces of text. Example models used by vector embedder 50 for obtaining these embeddings are typically transformer encoders, which are trained to distinguish if two pieces of text were consecutive in their original source such as discussed in the article entitled “Text and Code Embeddings by Contrastive Pre-Training” https://arxiv.org/abs/2201.10005 Submitted 24 Jan. 2022.

Furthermore, vector embedder 50 may also employ advanced techniques like “Matrioska Representation Learning” as described in the article “New Embedding Models and API updates”, https://openai.com/index/new-embedding-models-and-api-updates_submitted Jan. 25, 2024, or other embedding compression methods, to reduce the dimensionality of vectors, thereby saving storage space. Once generated, the embedded vectors are then saved into vector database 40.

It will be appreciated that the feature representations stored in features database 20 and their embedded counterparts in vector database 40 are maintained in synchronization. Database synchronizer 80 may ensure that if a feature is deleted from one of the databases 20 and 40, it is always deleted from the other. This may be according to scheduling timetables and data validation processes. Database synchronizer 80 may further implement versioning of features. If a change is made to an existing feature (that is already embedded), then upon such a change (received from feature receiver and cataloger 10), feature serializer 30 may receive the modified feature from database synchronizer 80 and perform the necessary transformation, enhancements and embeddings and output generator 34 may override the previous definition stored in vector database 40 by saving it under the same feature identifier.

In some embodiments, database synchronizer 80 may further provide a bulk synchronization or synchronization process that is invoked under particular system level conditions. For example, when system 100 is first integrated with an already existing feature store, database synchronizer 80 may iteratively retrieve each stored feature definition from feature database 20 (or from an external feature store), route the feature definition through feature serializer 30 and vector embedder 50, and populate vector database 40 so that each legacy feature obtains a corresponding semantic embedding.

In another example, if the configuration of vector embedder 50 is changed (for instance, to use a different embedding model, different dimensionality or different training technique), database synchronizer 80 may drop or invalidate existing tables or indexes in vector database 40 and re execute the sync process over the full set of feature definitions. Similarly, when the schema or structure of the feature definition object is modified (for example, by adding new fields or changing event filter representations), database synchronizer 80 may perform a full or partial re serialization and re embedding of affected features so that vector database 40 remains consistent with feature database 20.

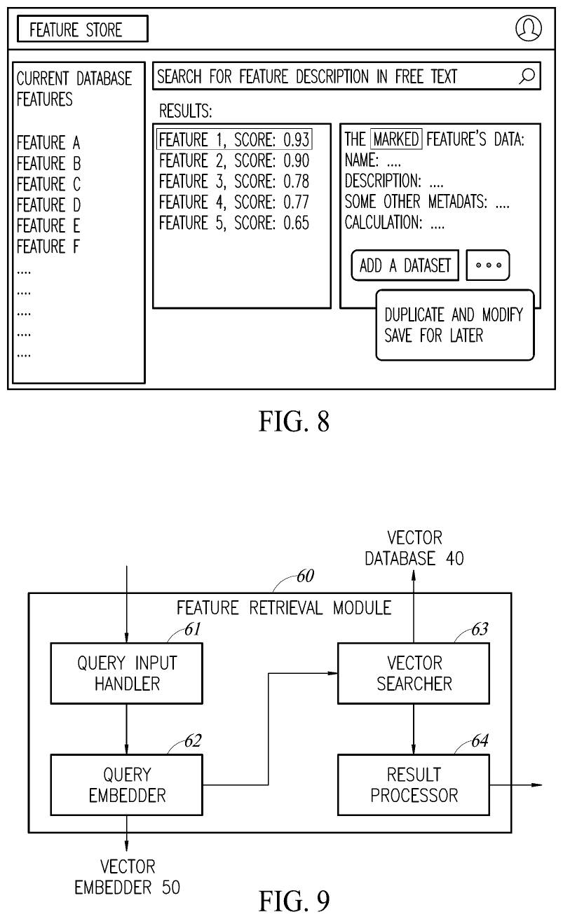

As discussed herein above, the purpose of system 100 is to enable an easy search for features using natural language. Reference is now made to FIG. 8 which illustrates an example user interface for data scientists or any other users to interact with system 100. FIG. 8 shows a user interface that allows data scientists to search for features using natural language, view search results with similarity scores, inspect the details of a selected feature, and then perform actions like adding it to their dataset, duplicating, and modifying it, or saving it for later use.

In some embodiments, when the search results presented in FIG. 8 do not contain a feature that satisfactorily meets the user's needs, the interface may provide a decision point that allows the user either to refine the search and attempt reuse of an existing feature, or to request creation of a new feature based on the same natural language description. In response to such a creation request, system 100 may invoke LLM 200 as described herein to generate a candidate structured feature definition consistent with the schema of FIGS. 3A-3D. The candidate feature definition may be displayed in the user interface for confirmation or editing and once accepted, stored in feature database 20 and embedded in vector database 40 as a newly created feature.

In some embodiments, whether a returned feature satisfies a user-specified criterion is determined based on one or more objective and/or user-configurable conditions. Nonlimiting examples include: (i) a similarity score exceeding a configurable threshold; (ii) at least one feature appearing within a top-k ranked list; (iii) a match against one or more user-specified required attributes (e.g., required event source, required filter fields, required aggregation type, or required time window); and/or (iv) an explicit user selection indicating that a presented feature is acceptable. The criterion, including any similarity threshold and/or top-k value, may be configured via the user interface, via an API parameter, and/or via a system configuration.

As discussed herein above, system 100 may be used with an external feature store. In this embodiment, since the feature database is external, feature serializer 30 may ensure that each feature in the store is transformed, enhanced, and embedded as described herein above.

Feature retrieval module 60 may serve as a client-facing component that enables semantic search within feature database 20 or feature store. Its core functionality involves receiving natural language queries or free-form inputs from clients via an exposed API. Upon receiving a query, it may embed this search input into a vector representation, which it then uses to perform a similarity search against the feature embeddings stored in vector database 40. This process yields a list of semantically matching features, optionally accompanied by their respective similarity scores, thereby enhancing feature discoverability.

Reference is now made to FIG. 9 which illustrates the sub elements of feature retrieval module 60. Feature retrieval module 60 may comprise a query input handler 61, a query embedder 62, a vector searcher 63 and a result processor 64.

Query input handler 61 may receive incoming search requests, specifically natural language queries, or other free-form textual inputs. It may ensure that the input is correctly formatted and prepared for further processing.

Query embedder 62 may take the textual search query received from query input handler 61 and process it through an integrated AI embedding model using vector embedder 50. Vector embedder 50 may convert the natural language text into a high-dimensional vector embedding (as described herein above in relation to the descriptive text received from LLM 200), where the semantic meaning of the query is encoded. The output is a numerical vector that can be compared mathematically with the feature embeddings stored in vector database 40.

Vector searcher 63 may receive the vector embedding of the user's query from query embedder 62 and search vector database 40 where the vectorized representations of all features are stored. It may execute a similarity search algorithm (such as k-nearest neighbors, approximate nearest neighbors) to compare the query vector against the vast collection of stored feature vectors. Vector searcher 63 may identify and retrieve features whose vector representations are most semantically similar to the input query vector, based on a defined similarity metric. In one non-limiting example, vector searcher 63 may compute cosine similarity between the normalized query vector and stored feature vectors and return the top-k nearest neighbors.

Result processor 64 may take the raw results from vector searcher 63 which typically include a list of feature identifiers and their calculated similarity scores and may organize and structure these results into a coherent output format. It may retrieve additional metadata or details for each identified feature from feature database 20 to enrich the search results. Result processor 64 may then compile this information into a ranked list of matching features, including their respective similarity scores, which is then prepared for transmission back to the requesting client or user interface as shown in FIG. 8.

Therefore, system 100 utilizes a semantic machine learning feature search and reusability, addressing the challenge of discovering and reusing complex machine learning features within feature stores. Feature serializer 30 may leverage LLMs to automatically translate intricate, structured feature definitions (like JSON or Protobuf objects) into rich, human-understandable natural-language descriptions. These semantic descriptions are then transformed into vector embeddings and stored in a vector database, enabling highly effective semantic searches based on natural language queries, thereby significantly enhancing feature discoverability, reducing duplication, and boosting data scientist productivity.

In some embodiments, system 100 may be further configured not only to support semantic search and reuse of existing feature definitions, but also to assist in automatic generation of new feature definitions when an appropriate existing feature cannot be found. In such embodiments, a user may provide a natural-language description of a desired feature, including (for example) a business goal, event filters, aggregation logic, and time windows.

In this scenario, the natural-language description of the desired feature may be processed by feature retrieval module 60 and/or feature serializer 30 and supplied to LLM 200 together with one or more templates from template repository 70. LLM 200 may then generate a proposed structured feature definition, such as a JSON or Protobuf object of the type illustrated in FIGS. 3A-3D, that encodes events, filters, aggregation or categorical rules, and associated metadata matching the conceptual description provided by the user. The generated structured feature definition may define, for example, event filters, base events, time windows, aggregation functions, and categorical parameters analogous to those shown in the example feature object of FIGS. 3A-3D.

System 100 may further present the LLM-generated feature definition to the user for review and optional modification via the user interface of FIG. 8. Upon user approval, feature receiver and cataloger 10 may treat the generated definition as a new feature definition, persist it in feature database 20 and cause feature serializer 30 and vector embedder 50 to generate and store a corresponding semantic embedding in vector database 40. In this way, system 100 may automatically create new features that conform to the same schema as existing features while significantly reducing the amount of manual feature engineering required from the user.

By combining semantic search, feature reuse and optional automatic generation of new feature definitions using LLM 200, system 100 may substantially improve the efficiency of feature engineering workflows. In some deployments, these capabilities have been observed to yield approximately an order of magnitude improvement in the time and effort required for data scientists to locate or create suitable features, relative to manual keyword search and hand crafted feature definition workflows.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for automatic generation of machine learning feature definitions, comprising:
a feature schema defining a structured representation of a machine learning feature, including event fields, filter fields and aggregation or categorical calculation fields;
a user interface configured to receive a natural language description of a desired feature from a user;
a large language model (LLM) configured to generate, based on said natural language description and said feature schema, a candidate feature definition that conforms to said structured representation; and
a feature database configured to store said candidate feature definition as a feature object for subsequent use in training or serving a machine learning model.

2. The system according to claim 1, wherein said natural language description comprises at least one of a business goal, event filters, aggregation logic, or time windows.

3. The system according to claim 1, further comprising a template repository configured to store one or more feature definition templates, and wherein said LLM is further configured to generate said candidate feature definition based on said natural language description, said feature schema, and at least one of said one or more feature definition templates.

4. The system according to claim 1, wherein said candidate feature definition generated by said LLM is a JSON or a Protobuf object.

5. The system according to claim 4, wherein said JSON or said Protobuf object encodes events, filters, aggregation or categorical rules, and associated metadata matching said natural language description.

6. The system according to claim 1, wherein said user interface is further configured to present said candidate feature definition to said user for review and optional modification, and wherein said feature database is configured to store said candidate feature definition upon receiving an approval from said user.

7. The system according to claim 6, further comprising a feature serializer, a vector embedder, and a vector database, wherein upon said user approval, said feature serializer and said vector embedder are configured to generate and store a corresponding semantic embedding of said candidate feature definition in said vector database.

8. The system according to claim 1, wherein said user interface comprises at least one of a web service, an application programming interface (API), a command-line-based interface, or a graphical user interface.

9. The system according to claim 1, wherein said feature schema defines said structured representation to comprise fields for a feature identifier, one or more data sources, filter conditions, and aggregation functions.

10. The system according to claim 1, wherein said user interface is further configured to receive said natural language description in response to a creation request from said user, said creation request being initiated following a semantic search that did not identify a feature satisfying a user-specified criterion.

11. A method for automatic generation of machine learning feature definitions, said method comprising:
receiving a natural language description of a desired feature from a user;
generating, utilizing a large language model (LLM) and based on said natural language description and a feature schema that defines a structured representation of a machine learning feature, including event fields, filter fields and aggregation or categorical calculation fields, a candidate feature definition that conforms to a structured representation defined by said feature schema, said structured representation including event fields, filter fields and aggregation or categorical calculation fields; and
storing said candidate feature definition as a feature object for subsequent use in training or serving a machine learning model.

12. The method according to claim 11, wherein said natural language description comprises at least one of a business goal, event filters, aggregation logic, or time windows.

13. The method according to claim 11, wherein said generating said candidate feature definition is further based on at least one of one or more stored feature definition templates.

14. The method according to claim 11, wherein said generated candidate feature definition is a JSON or a Protobuf object.

15. The method according to claim 14, wherein said JSON or said Protobuf object encodes events, filters, aggregation or categorical rules, and associated metadata matching said natural language description.

16. The method according to claim 11, further comprising: presenting said candidate feature definition to said user for review and optional modification; and receiving an approval from said user prior to said storing of said candidate feature definition.

17. The method according to claim 16, further comprising, upon receiving said approval from said user: generating a corresponding semantic embedding of said candidate feature definition;
and storing said semantic embedding.

18. The method according to claim 11, wherein said receiving said natural language description is performed via at least one of a web service, an application programming interface (API), a command-line-based interface, or a graphical user interface.

19. The method according to claim 11, wherein said structured representation defined by said feature schema further comprises fields for a feature identifier, one or more data sources, filter conditions, and aggregation functions.

20. The method according to claim 11, wherein said receiving said natural language description is performed in response to a creation request from said user, said creation request being initiated following a semantic search that did not identify a feature satisfying a user-specified criterion.
